(19) United States
(12) Patent Application Publication
(10) Pub. No.: US 2016/0121796 A1
(43) Pub. Date: May 5, 2016

(54) Mirror Adjustment Unit and Exterior Mirror for a Motor Vehicle Comprising Such a Mirror Adjustment Unit

(71) Applicant: MCi (Mirror Controls International) Netherlands B.V., Woerden (NL)

(72) Inventor: Stefan Frits Brouwer, Woerden (NL)

(21) Appl. No.: 14/888,065

(22) PCT Filed: May 16, 2014
(86) PCT No.: PCT/NL2014/050313

§ 371 Date: Oct. 29, 2015

(30) Foreign Application Priority Data
May 16, 2013 (NL) 2010811

(51) Int. Cl. B60R 1/072

(52) U.S. Cl. CPC B60R 1/072

(57) ABSTRACT

A mirror adjustment unit for an exterior mirror (1) comprises a base frame (11) and a mirror support (9). The mirror support is rotatable relative to the base frame via an adjusting mechanism (14a, 14b) including a first and second electrically energizable driving device (15, 16) for rotating the mirror support relative to the base frame with respect to a first and a second axis, respectively. The second axis is perpendicular to the first axis. The first and second driving device have a first and second electrical connector (17, 18), respectively, arranged on the base frame, for electrical connection of the first and the second driving device, respectively, with an on board network (4) of a motor vehicle to which the base frame is connectable. The mirror adjustment unit further has a third connector (22, 23) for electrical connection of a view assist device (19) with the onboard network. The third electrical connector is placed between, and electrically connected with, on one side, the first and second electrical connectors and, on the other side, the view assist device.

This invention generally relates to a mirror adjustment unit for an exterior mirror of a motor vehicle, comprising a base frame which can be fixedly connected with a motor vehicle, and a mirror support for supporting a mirror element, which mirror support is connected rotatably relative to the base frame via an adjusting mechanism, and wherein there is provided an electrical connection between the base frame and the mirror support.

Such a mirror adjustment unit is for instance known from Dutch patent NL-C-1019524 and is used to rotatably incorporate a mirror element in an exterior mirror of a motor vehicle, such that a driver can adjust the angular position of the mirror element relative to the vehicle to adjust his field of vision in rearward direction from the driver's seat via the mirror element. To that end, the mirror adjustment unit is provided with electrical driving means to enable the mirror element to be electrically rotated or pivoted, while the mirror support is often integrated with a mirror support plate. Also, the known mirror adjustment unit is provided with one or more so-called view assist devices which serve to realize additional functions for the purpose of the use of the mirror, such as, for instance, mirror heating, electric dimming of light shining in, and keeping the mirror water-free through vibrations. The electric components with which such functions are realized, for instance a heating element, an electrochrome glass or an ultrasonic motor, are arranged on the mirror support or mirror support plate. For activating or energizing these view assist devices the mirror adjustment unit according to NL-C-1019524 includes an electrical connection between the base frame and the mirror support, that comprises a pair of contact parts disposed movably relative to each other, which jointly form a sliding contact for maintaining the electrical contact during rotation of the mirror support relative to the base frame, while one of the contact parts of the sliding contact is fixedly connected with the mirror support and the other with the adjusting mechanism. The disadvantage of such a sliding contact, however, is that upon frequent rotation of the mirror support relative to the base frame, the sliding contact may wear out and the electrical connection thereby provided no longer functions correctly under all circumstances, in particular when the view assist devices are arranged on the mirror itself.

Further, there is a trend to realize more and more electrical functions for the purpose of the use of the mirror. Consequently, because of the extra wire outputs or connecting wires from the base frame to the onboard network of a vehicle that are needed for each electrical function, it is difficult in practice to provide for a sufficiently flexible electrical connection. In addition, it is time consuming not only to arrange a bundled electrical connection between the vehicle and the base frame but also to provide the electrical connections for each electrical function between the base frame and the mirror support, which may regularly give rise to connecting errors. Also, it appears that errors can be made in placing or replacing mirror elements which contain view assist devices. For the purpose of the supply of these devices, the mirror elements include upstanding pins which make the mirror elements with view assist devices high and fragile and, in particular, make such elements difficult to stack.

This is a problem in particular when it is taken into account that the mirror support is often supplied as a subassembly, the mirror support being provided with a mirror element and a number of electrical components for fulfilling utility functions of the mirror, such as a heating element, electrochrome glass or ultrasonic motor. Further, the subassembly mentioned is often supplied by a different supplier than the supplier of the other parts of the mirror adjustment unit, which likewise constitute a subassembly. Often, the two subassemblies of the mirror adjustment unit then have to be electrically connected with each other in a reliable manner in large numbers by a third party. As the two subassemblies of the mirror adjustment unit are each made up of a large number of components, this can entail an accumulation of dimensional tolerances, which makes assembly of the mirror adjustment unit time-consuming and hence costly.

The object of the invention is to provide a mirror adjustment unit where, while preserving the advantages, the disadvantages mentioned can be counteracted. In particular, the invention contemplates a mirror adjustment unit whereby the electrical connection between a view assist device, in particular a view assist device arranged on the mirror element, can be accomplished in a reliable and efficient manner with a relatively small number of electrical connecting wires from an onboard network of a vehicle to the mirror adjustment unit.

To this end, the invention provides a mirror adjustment unit for an exterior mirror of a motor vehicle according to claim 1, a mirror adjustment unit for an exterior mirror of a motor vehicle, comprising a base frame which is connectable with a motor vehicle and a mirror support for supporting a mirror element, which mirror support is connected rotatably relative to the base frame via an adjusting mechanism, wherein the adjusting mechanism is provided with a first electrically energizable driving device for rotating the mirror support relative to the base frame with respect to a first axis, and with a second electrically energizable driving device for rotating the mirror support relative to the base frame with respect to a second axis, wherein the second axis is at least approximately perpendicular to the first axis, wherein the first driving device is provided with a first electrical connector arranged on the base frame for electrical connection of the first driving device with an onboard network of a motor vehicle to which the base frame is connectable, and wherein the second driving device is provided with a second electrical connector arranged on the base frame for electrical connection of the second driving device with the onboard network, wherein the mirror adjustment unit further comprises a third electrical connector for electrical connection of an electrically energizable view assist device with the onboard network, which electrically energizable view assist device is arranged on the adjusting mechanism or is arranged on the mirror element to be supported by the mirror support, wherein the third electrical connector is placed between, and electrically connected with, on one side, the first and second electrical connectors and, on the other side, the electrically energizable view assist device. By making use, according to the invention, of the already present electrical connectors for the electrically energizable driving devices, an electrical connection belonging to the mirror adjustment unit, in particular an internal one, will suffice for the supply of a view assist device, without necessitating additional electrical connections from the mirror adjustment unit to the onboard network of the vehicle.

In an embodiment of a mirror adjustment unit according to the invention, the third electrical connector comprises spring elements. Such spring elements are particularly suitable for maintaining an electrical connection between a view assist device and a base frame that are rotatable relative to each other during mirror adjustment. It is then advantageous when on the view assist device two contact surfaces are provided against which the spring elements abut. Preferably, the spring elements are implemented as helical springs which provide sufficient compressive stress for providing electrical contact at all times. In an embodiment in which the view assist device and the base frame are not rotatable relative to each other during mirror adjustment, the third electrical connector can contain non-spring, that is, rigid elements.

In an alternative embodiment of a mirror adjustment unit, the third electrical connector comprises a flexible current conductor, in other words, a current conductor which is bendable in a direction transversely to its extension, but does not provide any bias in a direction of its extension. It is then particularly advantageous when the flexible current conductor is implemented as a so-called flex-foil.

In a further embodiment of a mirror adjustment unit according to the invention, in which the electrically energizable view assist device is arranged on a mirror element to be supported by the mirror support, a correct and reliable electrical connection can be realized when the third electrical connector comprises an intermediate connector, arranged on the mirror support, for electrical connection of the electrically energizable view assist device with the onboard network via the intermediate connector, which intermediate connector is electrically connected with the first and second electrical connectors and is electrically connectable with the electrically energizable view assist device arranged on the mirror element.

According to a still further embodiment of the invention, a compact mirror adjustment unit can be obtained with a reliable electrical connection to the view assist devices when the first electrically energizable driving device comprises a first motor with a first electrically conductive motor casing and/or the second electrically energizable driving device comprises a second motor with a second electrically conductive motor casing, wherein the first and/or second motor casing is electrically connected with the first and second electrical connector, respectively, and wherein the third electrical connector comprises the first and/or second motor casing. By connecting one of the two supply poles of the first and/or second electrical connector with the (metal) motor casing, not only disturbing radiation emission is reduced or obviated, but also, because of the nature of the make-up of the adjusting mechanism, the motor casings, after assembly of the mirror element, extend to a point just below the mirror element, so that a compact construction can be obtained as well.

In an embodiment of a mirror adjustment unit according to the invention, the first and second electrical connectors each include two separate electrical connecting elements, which results in four connecting elements (or supply poles) overall. In an alternative variant of a mirror adjustment unit according to the invention, the first and second electrical connectors each include one separate electrical connecting element and one common connecting element, which results in three connecting elements, with the common connecting element forming the ground. Both types (i.e., three or four connecting elements) are conventionally used in the vehicle technique and require exclusively standard connectors, so that a mirror adjustment unit according to the invention, where connectors are concerned, does not require any modifications. The first and second electrical connectors are preferably included in one common connector housing, such as an exterior mirror connector, so that there is one common connector output which is connectable with a single cable bundle for supplying or energizing the first and second driving devices and the one or more view assist devices.

What is thereby achieved is that the electrical connection can be easily made of multiple design, while preserving the flexibility of the electrical connection.

The invention also relates to an exterior mirror for a motor vehicle, comprising a mirror adjustment unit according to any one of the mirror adjustment unit claims and a mirror element arranged on the mirror support.

In an advantageous embodiment of an exterior mirror according to the invention in which it is possible to supply two different view assist devices with just one third electrical connector, for instance one pair of compression springs, the exterior mirror comprises at least two separate electrically energizable view assist devices, wherein the at least two separate electrically energizable view assist devices are arranged on the adjusting mechanism or are arranged on the mirror element or one electrically energizable view assist device is arranged on the adjusting mechanism and the other view assist device is arranged on the mirror element, wherein the exterior mirror is so constructed that in use with an electrical connection with a first polarity exclusively one of the view assist devices is activated while with an opposite polarity the other of the view assist devices is activated or both view assist devices are activated.

The invention will be further elucidated on the basis of a number of exemplary embodiments which are represented in a drawing. In the drawing:

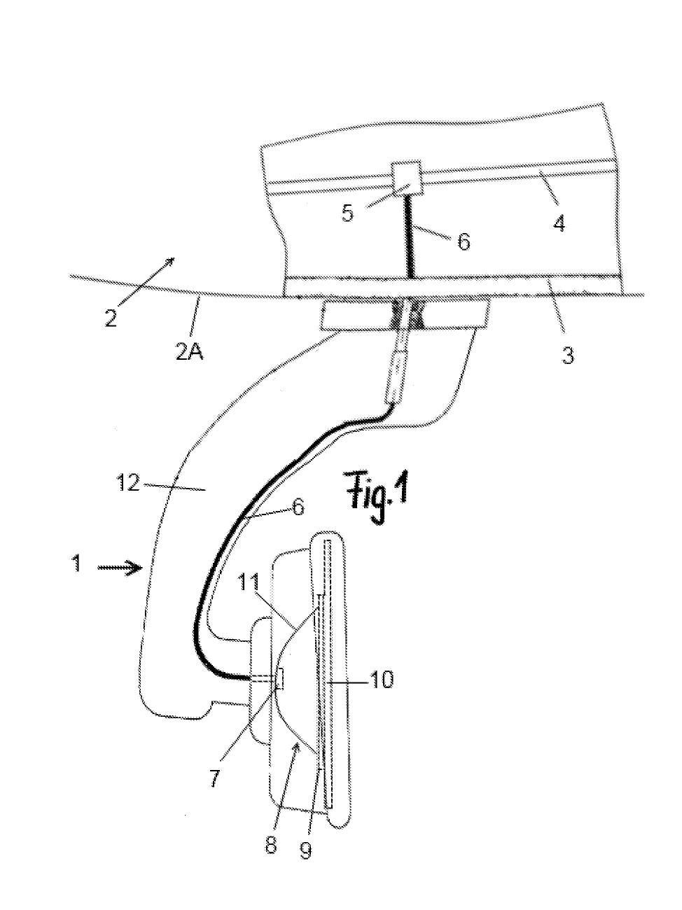

FIG. 1 shows a schematic view of an exterior mirror mounted on a door of a vehicle;

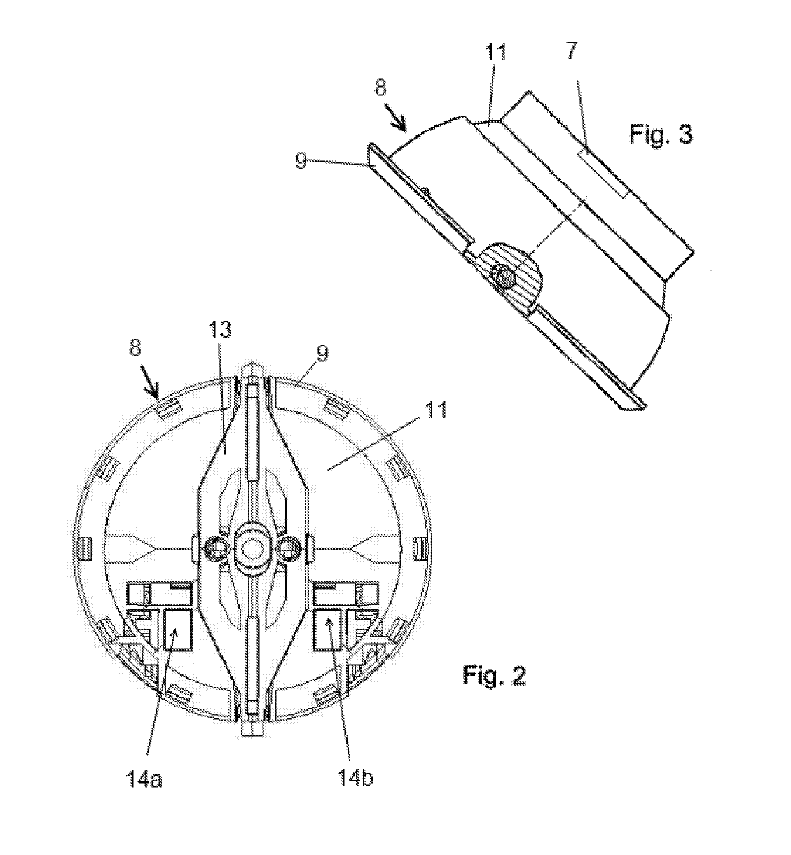

FIG. 2 shows a schematic top plan view of a mirror adjustment unit for an exterior mirror shown in FIG. 1;

FIG. 3 shows a schematic side view of the mirror adjustment unit of FIG. 2;

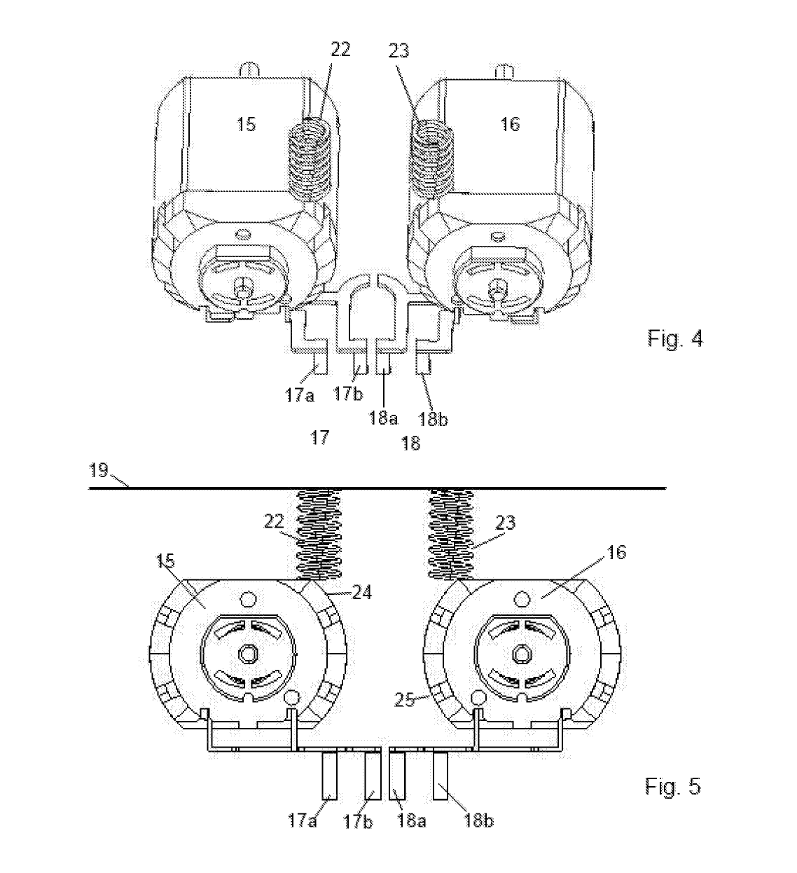

FIG. 4 shows a schematic top plan view in perspective of motors and electrical connectors of the mirror adjustment unit of FIGS. 2 and 3;

FIG. 5 shows a schematic front view of FIG. 4 with heater pad;

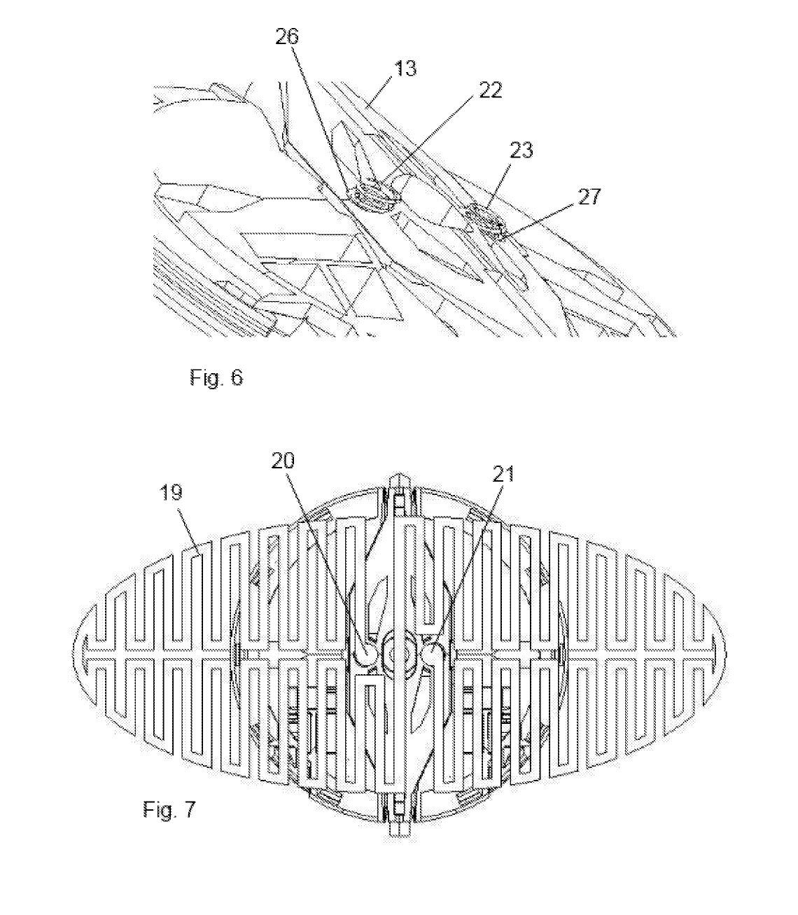

FIG. 6 shows a schematic view in perspective of a part of a crosspiece with, sticking through it, helical springs of the mirror adjustment unit of FIGS. 2 to 5;

FIG. 7 shows a schematic top plan view of a heater pad arranged on the mirror adjustment unit; and

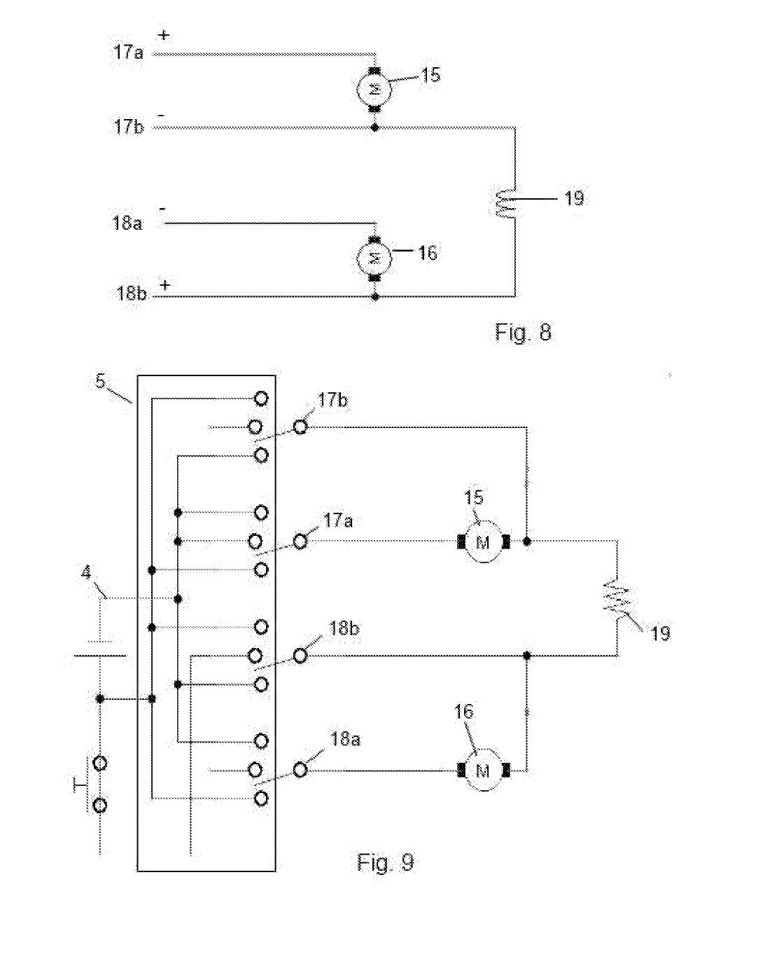

FIGS. 8 and 9 show examples of electrical circuits to be used in the mirror adjustment unit according to the invention.

The figures are only schematic representations of preferred embodiments of the invention. In the figures, the same or corresponding parts are indicated with the same reference numerals.

FIG. 1 shows a schematic representation of an exterior mirror 1 of a motor vehicle 2. The exterior mirror 1 in this exemplary embodiment is mounted on the outside 2A of a door 3 of the motor vehicle 2. In the door 3 of the motor vehicle 2 runs a part of the electrical onboard network 4 of the motor vehicle 2, which onboard network 4 advantageously comprises a distribution branch 5 with a control chip for electrically supplying electrically controllable means of the exterior mirror 1 via an exterior mirror feeder cable 6. The exterior mirror feeder cable 6 is connected with an exterior mirror connector 7 of a mirror adjustment unit 8 which comprises a mirror support 9 for supporting a mirror element 10. The mirror adjustment unit 8 further comprises a base frame 11 which can be connected with the motor vehicle 2, in particular by attaching it to a support construction 12 which is pivotably mounted on the door 3 of the motor vehicle 2 in a conventional manner.

In FIG. 2, schematically, a top plan view is shown of a mirror adjustment unit 8 according to the invention, while in FIG. 3 a schematic side view is shown. It is noted that the mirror support 9 is here represented as a ring-shaped element, but that the invention is not limited thereto. In particular, in embodiments not shown, it is possible that on the mirror support 9 and the crosspiece 13 a support plate can be mounted on which the mirror element is mountable. In general, such a construction of a mirror adjustment unit 8 whereby the mirror support 9 is rotatable relative to the base frame 11 via an adjusting mechanism 14a, 14b, is known, as described, for instance, in EP-A-1347890.

As is represented in FIGS. 4 and 5, the adjusting mechanism 14a,14b is provided with a first electrically energizable driving device, in this case a first motor 15 for rotating the mirror support 9 relative to the base frame 11 with respect to a first axis, and with a second electrically energizable driving device, in this case also a motor 16 for rotating the mirror support 9 relative to the base frame 11 with respect to a second axis, the second axis being at least approximately perpendicular to the first axis.

The first motor 15 is provided with a first electrical connector 17, arranged on the base frame 11, for electrical connection of the first motor 15 with the onboard network 4. Also provided is a second electrical connector 18, arranged on the base frame 11, for electrical connection of the second motor 16 with the onboard network 4. The first and second electrical connectors 17, 18 jointly form the exterior mirror connector 7.

In the embodiment as represented in FIGS. 4 and 5, the first and second electrical connectors 17, 18 each include two separate electrical connecting elements or supply poles 17a, 17b; 18a, 18b. In alternative embodiments not shown, the first and second electrical connectors each include one separate electrical connecting element and one common connecting element. For the description of the invention, the starting point will be the embodiment with two supply poles per electrical connector. The invention will further be clarified on the basis of an embodiment in which the electrically energizable view assist device is a heating device 19, also called heater pad, arranged on the mirror element. It will be clear to those skilled in the art that the invention also applies to other view assist devices which, for instance, may also be integrated in the mirror support 9 or the crosspiece 13. In that case, the mirror support, or the crosspiece, forms an intermediate connector which can further, in a manner know per se, be electrically connected with the heater pad, for instance with the aid of a plug connection. In addition, a separate intermediate connector, for instance integrated in the above-mentioned support plate, can be used, which intermediate connector is connected on one side, internally, with the first and second electrical connector 17, 18 and on the other side with the heater pad 19.

Such a heater pad 19 is shown in FIG. 5 in front view and in FIG. 7 in top plan view and includes contact surfaces 20, 21 for enabling electrical connection with the first and second electrical connectors 17, 18.

This last mentioned electrical connection is realized according to the invention in that the mirror adjustment unit 8 further comprises a third electrical connector for the electrical connection of the heater pad with the onboard network 4, which third electrical connector is placed between the first and second electrical connectors 17, 18 and the heater pad 19 and is electrically connected with the first and second electrical connectors 17, 18. In the embodiment shown, this third electrical connector is formed by spring elements implemented as helical springs 22, 23. The helical spring 22, in any case in use, is in electrical contact with a first electrically conductive motor casing 24 of the first motor 15, which motor casing is electrically connected with the supply pole 17b. Analogously, the helical spring 23, in any case in use, is in electrical contact with a second electrically conductive motor casing 25 of the second motor 16, which motor casing 25 is electrically connected with the supply pole 18b. The third electrical connector hence comprises both the helical springs 22, 23 and the electrically conductive motor casings 24, 25, whereby the helical springs 22, 23, which, as represented in FIG. 6, stick out of openings 26, 27 in the crosspiece 13, provide—after mounting of the mirror element—for a correct electrical connection with the contact surfaces of the heater pad.

In alternative embodiments and/or for the electrical supply of other view assist devices, the third electrical connector can comprise a flexible current conductor, preferably implemented as flex-foil, or even relatively rigid electrical connecting wires.

In FIGS. 8 and 9 two examples of electrical circuits for the supply of the heater pad 19 are represented, FIG. 9 showing a circuit diagram whereby in one switch setting only the adjusting function of the adjusting mechanism can be activated and in the other switch setting the heater pad can be activated. Such a switching device can be integrated in a simple manner in the distribution branch 5 with control chip so that the driver of the vehicle, at will, can adjust the mirror element or can activate the heater pad.

If the exterior mirror 1 comprises at least two separate electrically energizable view assist devices, for instance a heater pad and a dimming device, then the exterior mirror 1 may be so constructed that, in use, with an electrical connection with first (+/−) or (−/+) polarity exclusively one of the view assist devices is activated, while, with an opposite (−/+) or (+/−) polarity the other of the view assist devices is activated or both view assist devices are activated.

1. A mirror adjustment unit for an exterior mirror of a motor vehicle, comprising:
a base frame which is connectable with a motor vehicle and a mirror support for supporting a mirror element, which mirror support is connected rotatably relative to the base frame via an adjusting mechanism,
wherein the adjusting mechanism is provided with a first electrically energizable driving device for rotating the mirror support relative to the base frame with respect to a first axis, and with a second electrically energizable driving device for rotating the mirror support relative to the base frame with respect to a second axis, wherein the second axis is at least approximately perpendicular to the first axis, wherein the first driving device is provided with a first electrical connector arranged on the base frame for electrical connection of the first driving device with an onboard network of a motor vehicle to which the base frame is connectable, and wherein the second driving device is provided with a second electrical connector arranged on the base frame for electrical connection of the second driving device with the onboard network,
wherein the mirror adjustment unit further comprises a third electrical connector for electrical connection of an electrically energizable view assist device with the onboard network, which electrically energizable view assist device is arranged on one of the adjusting mechanism or the mirror element to be supported by the mirror support, wherein the third electrical connector is placed between, and electrically connected with, on one side, the first and second electrical connectors and, on a second side, the electrically energizable view assist device.

2. The mirror adjustment unit according to claim 1, wherein the third electrical connector comprises spring elements.

3. The mirror adjustment unit according to claim 2, wherein the spring elements are implemented as helical springs.

4. The mirror adjustment unit according to claim 1, wherein the third electrical connector comprises a flexible current conductor.

5. The mirror adjustment unit according to claim 4, wherein the flexible current conductor is implemented as flex-foil.

6. The mirror adjustment unit according to claim 1, wherein the electrically energizable view assist device is arranged on a mirror element to be supported by the mirror support, and wherein the third electrical connector comprises an intermediate connector arranged on the mirror support for electrical connection of the electrically energizable view assist device with the onboard network via the intermediate connector, which intermediate connector is electrically connected with the first and second electrical connectors and is electrically connectable with the electrically energizable view assist device arranged on the mirror element.

7. The mirror adjustment unit according to claim 1, wherein the first electrically energizable driving device comprises a first motor with a first electrically conductive motor casing and/or the second electrically energizable driving device comprises a second motor with a second electrically conductive motor casing, wherein the first and/or second motor casing is electrically connected with the first and second electrical connector, respectively, and wherein the third electrical connector comprises the first and/or second motor casing.

8. The mirror adjustment unit according to claim 1, wherein the first and second electrical connectors each contain two separate electrical connecting elements.

9. The mirror adjustment unit according to claim 1, wherein the first and second electrical connectors each contain one separate electrical connecting element and one common connecting element.

10. An exterior mirror for a motor vehicle comprising a mirror adjustment unit according to claim 1 and a mirror element arranged on the mirror support.

11. The exterior mirror according to claim 10, wherein the exterior mirror comprises at least two separate electrically energizable view assist devices, wherein the at least two separate electrically energizable view assist devices are arranged on the adjusting mechanism or are arranged on the mirror element or one electrically energizable view assist device is arranged on the adjusting mechanism and the other view assist device is arranged on the mirror element, wherein the exterior mirror is so constructed that, in use, with an electrical connection with a first polarity exclusively one of the view assist devices is activated, while with an opposite polarity the other of the view assist devices is activated or both view assist devices are activated.
